(19) United States
(12) Patent Application Publication
(10) Pub. No.: US 2020/0137999 A1
(43) Pub. Date: May 7, 2020

(54) Rod Caddy

(71) Applicant: David Bruce Smith, Northville, MI (US)

(72) Inventor: David Bruce Smith, Northville, MI (US)

(21) Appl. No.: 16/620,521

(22) PCT Filed: Jun. 8, 2018
(86) PCT No.: PCT/US18/36737

§ 371 Date: Dec. 8, 2019

(51) Int. Cl. A01K 97/08

(52) U.S. Cl. CPC A01K 97/08

(57) ABSTRACT

A rod caddy comprising a first tube having a first end and a second end, a second tube having a third end and a fourth end, a resilient connector having a first tube end and a second tube end, a first attachment means for connecting the first tube end to the first end; and, a second attachment means for connecting the second tube end to the third end. The first tube is hollow. The first end is open. The second end is closed. The second tube is hollow. The third end is open. The fourth end is closed.

### CROSS-REFERENCE TO RELATED APPLICATIONS

The present application claims priority to provisional U.S. patent application Ser. No. 62/516,695, filed Jun. 8, 2017, and entitled “Tip protector for fishing rod,” and to provisional U.S. patent application Ser. No. 62/621,628, filed Jan. 25, 2018, and entitled “Dave's rod caddy 2,” the disclosures of which are incorporated herein by reference in their entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to fishing rod carriers. Generally, fishermen store and/or transport their fishing rods either with the rod disassembled in half and then with the line around the two halves of the rod, with the hook in a guide and the line tightened to keep the hook in place, among other ways. The fishing rod, the reel, the tip, the guides and/or the ferrules may be damaged during storage or transport. Additionally, the line may become tangled. The present invention solves these and other problems.

### BRIEF SUMMARY OF THE INVENTION

An embodiment of the present invention is a rod caddy comprising a first tube having a first end and a second end, a second tube having a third end and a fourth end, a resilient connector having a first tube end and a second tube end, a first attachment means for connecting the first tube end to the first end; and, a second attachment means for connecting the second tube end to the third end. The first tube is hollow. The first end is open. The second end is closed. The second tube is hollow. The third end is open. The fourth end is closed.

In another embodiment of the present invention, for the first attachment means, the first end has a first end aperture. The first tube end is attached to the first end aperture. For the second attachment means, the third end has a third end aperture. The second tube end is attached to the third end aperture.

In yet another embodiment of the present invention, the resilient connector is a bungee cord.

In another embodiment of the present invention, the first tube has at least one perforation.

In yet another embodiment of the present invention, the second tube has at least one perforation.

In another embodiment of the present invention, the resilient connector is a rubber cord.

In yet another embodiment of the present invention, for the first attachment means, the first end has a first end protuberance. The first tube end has at least one first tube end hole. The at least first tube end hole is configured to releasably engage the first end protuberance.

In another embodiment of the present invention, for the second attachment means, the third end has a third end protuberance. The second tube end has at least one second tube end hole. The at least one second tube end hole is configured to releasably engage the third end protuberance.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a perspective view of an embodiment of the present invention.

FIG. 2 is a perspective view of an embodiment of the present invention.

FIG. 3 is a perspective view of an embodiment of the present invention.

FIG. 4 is a perspective view of an embodiment of the present invention.

For clarity purposes, all reference numerals may not be included in every figure.

### DETAILED DESCRIPTION OF THE INVENTION

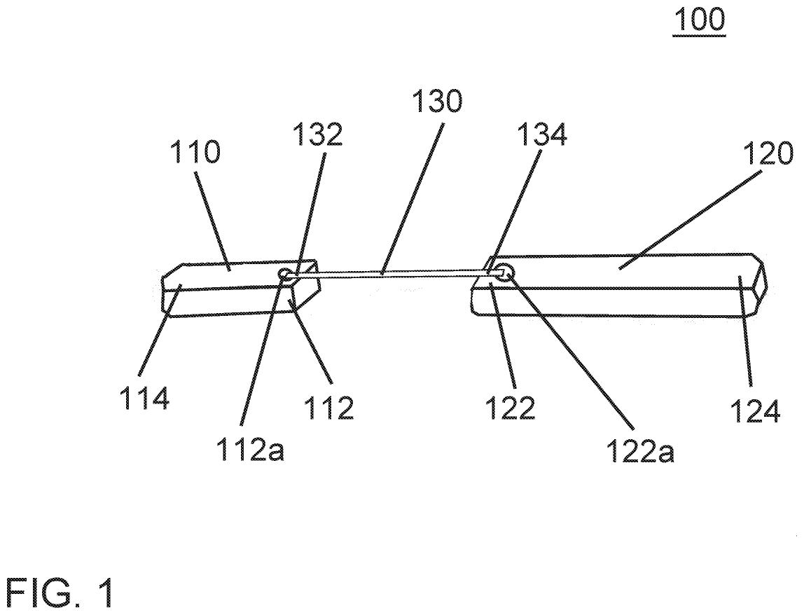

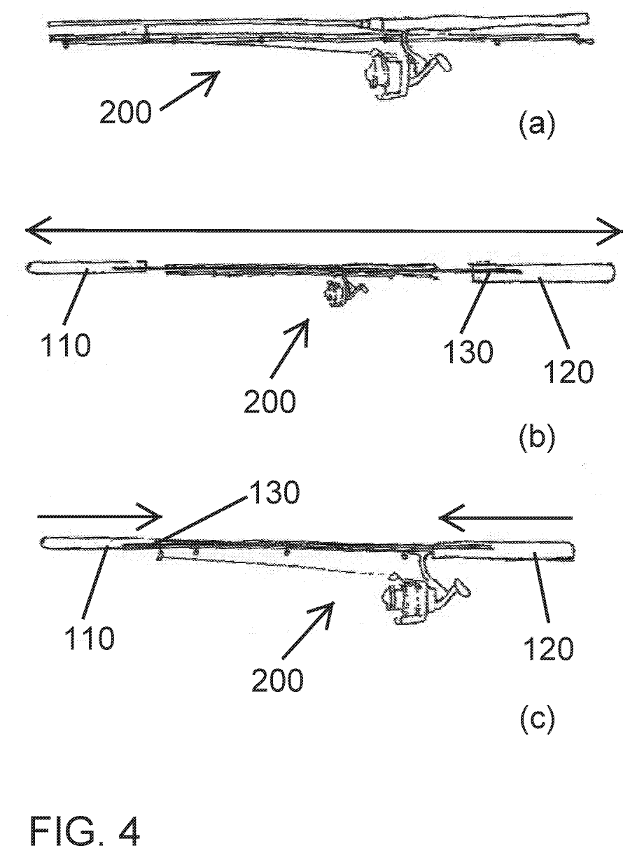

FIGS. 1-4 illustrate a rod caddy 100 comprising a first tube 110 having a first end 112 and a second end 114; a second tube 120 having a third end 122 and a fourth end 124; a resilient connector 130 having a first tube end 132 and a second tube end 134; a first attachment means for connecting the first tube end 132 to the first end 112; and, a second attachment means for connecting the second tube end 134 to the third end 122. The first tube 110 is hollow. The first end 112 is open. The second end is closed 114. The second tube 120 is hollow. The third end 122 is open. The fourth end 124 is closed. The first tube 110 and the second tube 120 are hollow and the first end 112 and the third end 122 are open to accept a fishing rod 200, as shown in FIG. 4. The second end 114 and fourth end 124 are closed to contain and protect the ends of the fishing rod 200.

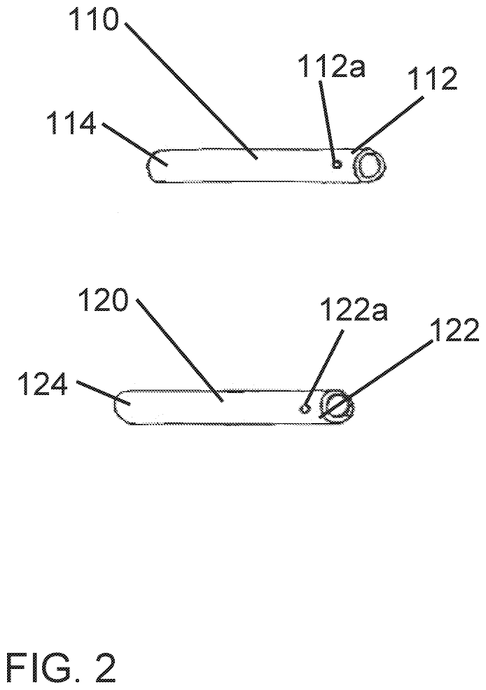

In one embodiment of the rod caddy 100, as illustrated in FIGS. 1 and 2, for the first attachment means, the first end 112 has a first end aperture 112a. The first tube end 132 is attached to the first end aperture 112a. For the second attachment means, the third end 122 has a third end aperture 122a. The second tube end 134 is attached to the third end aperture 122a. For example, the first tube end 132 and the second tube end 134 are slipped through the first end aperture 112a and the third end aperture 122a, respectively. The first tube end 132 and the second tube end 134 are knotted to connect the first tube 110 to the second tube 120 and to attach the resilient connector 130 to both the first tube 110 to the second tube 120. The length of the rod caddy 100 may be adjusted by changing the position of the knots. This advantageously allows the rod caddy 100 to be used for various sized fishing rods 200.

In some embodiments, the resilient connector 130 is a bungee cord. In other embodiments, the resilient connector 130 is a rubber cord.

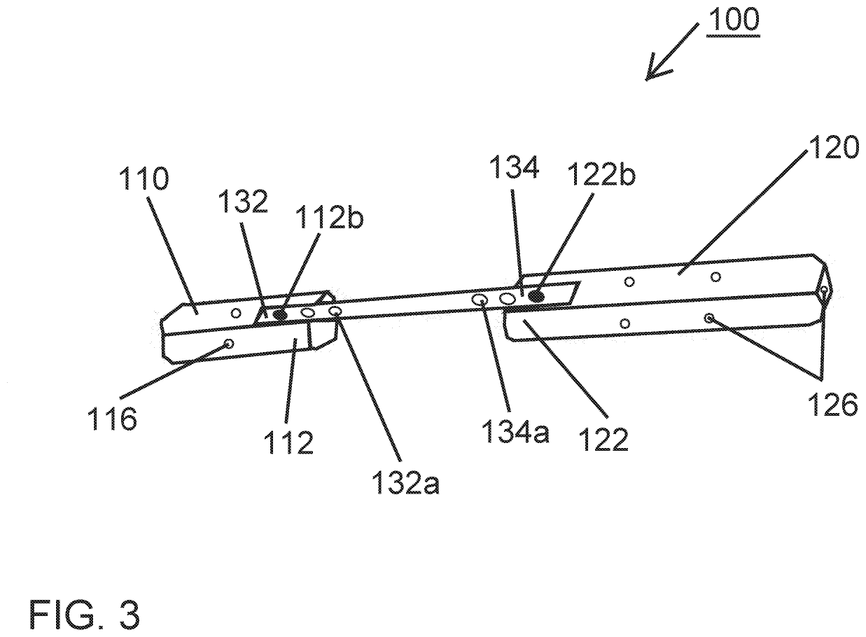

In some embodiments, the first tube 110 has at least one perforation 116, as illustrated in FIG. 3. In other embodiments, the second tube 120 has at least one perforation 126, as illustrated in FIG. 3. Other embodiments may have both perforations 116, 126 in both the first tube 110 and second tube 120. The perforations 116, 126 may serve as a drainage for water that may be in the first tube 110 and second tube 120. The perforations 116, 126 may serve as vents to aid in evaporation of moisture that may be in the first tube 110 and second tube 120. The perforations 116, 126 may be located anywhere on the first tube 110 and second tube 120.

In another embodiment, as illustrated in FIG. 3, for the first attachment means, the first end 112 has a first end protuberance 112b. The first tube end 132 has at least one first tube end hole 132a. The at least first tube end hole 132a is configured to releasably engage the first end protuberance 112b.

In some embodiments, for the second attachment means, the third end 122 has a third end protuberance 122b. The second tube end 134 has at least one second tube end hole 134a. The at least one second tube end hole 134a is configured to releasably engage the third end protuberance.

In other embodiments, the rod caddy 100 may have both a first end protuberance 112b and a third end protuberance 122b with their respective first tube end holes 132a and second tube end holes 134a.

FIG. 3 is an illustrative example, where the resilient connector 130 is a rubber cord with first tube end holes 132a and second tube end holes 134a. To attach the resilient connector 130 to the first tube 110, the first tube end 132 is stretched to enlarge the first tube end hole 132a and placed over the first end protuberance 112b. Then, the first tube end 132 is released to the reduce the first tube end hole 132a to its original and natural size. Similarly, to attach the resilient connector 130 to the second tube 120, the second tube end 134 is stretched to enlarge the second tube end hole 134a and placed over the third end protuberance 122b. Then, the second tube end 134 is released to the reduce the second tube end hole 134a to its original and natural size. Some embodiments may have more than one first tube end hole 132a. Some embodiments may have more than one second tube end hole 134a. Having more than one first tube end hole 132a and second tube end hole 134a allows for adjusting the length of the rod caddy 100. This advantageously allows the rod caddy 100 to be used for various sized fishing rods 200.

The first end protuberance 112b and the third end protuberance 122b may be configured to accept and engage the first tube end holes 132a and second tube end holes 134a, respectively. For example, the first end protuberance 112b and the third end protuberance 122b may be shaped like a mushroom or a “T” to facilitate the engagement of the first tube end holes 132a and second tube end holes 134a, respectively.

FIG. 4 illustrates one way of utilizing the rod caddy 100. The fishing rod 200 may be left assembled (not illustrated), or disassembled, as illustrated in FIG. 4a. Once disassembled, the ferrules of the fishing rod 200 placed together and inserted into the first tube 110. The resilient connector 130 is then stretched (as illustrated in FIG. 4b by the double-headed arrow) to the proper length to allow the handle and tip to be inserted into the second tube 120. When the second tube is released (as illustrated in FIG. 4c by the two single-headed arrows), the resilient connector 130 contracts towards its normal state and the tension holds the fishing rod 200 within the rod caddy 100.

The first tube 110 and second tube 120 may be made of plastic, metal, cloth fiber, wood, carbon fiber, glass, or combinations thereof. The first tube 110 and second tube 120 may be in any suitable shape, such as round, triangular, hexagonal, square, or combinations thereof. The first tube 110 and second tube 120 may have the same or different dimensions. Each of the first tube 110 and second tube 120 may vary in size. For example, each of the first tube 110 and second tube 120 may have a cross section area ranging from 0.015 square inches to 180 square inches; a length ranging from 1 inch to 172 inches; and, a thickness ranging from 0.001 of an inch to 1 inch.

The resilient connector 130 may be an elastic cords, bungee cords, rubber cords, or combinations thereof. Elastic cords may be made of polypropylene, cotton, nylon, polyester, or combinations thereof. A polypropylene elastic cord has natural UV protection. The resilient connector 130 may be flat or round. Bungee cords are usually rubber bound together by a fabric covering, e.g., nylon wrapped rubber cords. The covering may be braided from cotton or nylon yarn, but, nylon is preferable because it is more resistant to abrasion and has a higher tensile strength. Rubber may be natural, synthetic, or combinations thereof. The resilient connector 130 may be fixed or adjustable. The dimensions of the resilient connector 130 may vary. For example, the resilient connector 130 may have a width ranging from 1/16 of inch to 6 inches wide and may have a length ranging from 6 inches to 240 inches.

The rod caddy 100 with an encapsulated fishing rod 200 may be carried by hand. Advantageously, due to the resilient connector 130, the rod caddy 100 may be slung over a fisherman's shoulder to be transported.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

I claim:

1. A rod caddy comprising:
a first tube having a first end and a second end;
a second tube having a third end and a fourth end;
a resilient connector having a first tube end and a second tube end;
a first attachment means for connecting the first tube end to the first end; and,
a second attachment means for connecting the second tube end to the third end;
wherein the first tube is hollow;
wherein the first end is open;
wherein the second end is closed;
wherein the second tube is hollow;
wherein the third end is open; and,
wherein the fourth end is closed.

2. The rod caddy of claim 1, wherein for the first attachment means, the first end has a first end aperture, and the first tube end is attached to the first end aperture; and,
wherein for the second attachment means, the third end has a third end aperture, and the second tube end is attached to the third end aperture.

3. The rod caddy of claim 2, wherein the resilient connector is a bungee cord.

4. The rod caddy of claim 3, wherein the first tube has at least one perforation.

5. The rod caddy of claim 4, wherein the second tube has at least one perforation.

6. The rod caddy of claim 2, wherein the resilient connector is a rubber cord.

7. The rod caddy of claim 6, wherein the first tube has at least one perforation.

8. The rod caddy of claim 7, wherein the second tube has at least one perforation.

9. The rod caddy of claim 1, wherein for the first attachment means, the first end has a first end protuberance;
wherein the first tube end has at least one first tube end hole; and,
wherein the at least first tube end hole is configured to releasably engage the first end protuberance.

10. The rod caddy of claim 9, wherein the resilient connector is a rubber cord.

11. The rod caddy of claim 10, wherein the first tube has at least one perforation.

12. The rod caddy of claim 11, wherein for the second attachment means, the third end has a third end protuberance;
wherein the second tube end has at least one second tube end hole; and,
wherein the at least one second tube end hole is configured to releasably engage the third end protuberance.

13. The rod caddy of claim 12, wherein the second tube has at least one perforation.
